(19) United States
(12) Patent Application Publication
(10) Pub. No.: US 2022/0052908 A1
(43) Pub. Date: Feb. 17, 2022

(54) ELECTRONIC DEVICE, METHOD, AND MEDIUM FOR GENERATING AND DETECTING ERRORS IN CONFIGURATION FILES

(71) Applicant: ARRIS Enterprises LLC, Suwanee, GA (US)

(72) Inventors: Linzhou Cai, Shenzhen (CN); Aoxue Li, Shenzhen (CN); Yonghua Yan, Shenzhen (CN); YuPing Dong, Shenzhen (CN); Haili Liu, Shenzhen (CN)

(73) Assignee: ARRIS Enterprises LLC, Suwanee, GA (US)

(21) Appl. No.: 17/241,647

(22) Filed: Apr. 27, 2021

(30) Foreign Application Priority Data
Aug. 12, 2020 (CN) 202010806576.2

(51) Int. Cl. H04L 12/24; G06F 3/0484

(52) U.S. Cl. CPC H04L 41/0672; G06F 3/04842; H04L 41/0803; H04L 41/22

(57) ABSTRACT

An electronic device to: present a Graphical User Interface (GUI) to a user, the GUI including a plurality of selectable elements and one or more parameter controls associated with each of the plurality of selectable elements, each of the plurality of selectable elements corresponding to a feature of a network access device; receive a user selection of at least one of the plurality of selectable elements; receive one or more parameter values associated with the at least one selectable element inputted by the user via the parameter controls; and generate a configuration file of the network access device based at least on the at least one selectable element selected by the user, and the one or more parameter values associated with the at least one selectable element inputted by the user, in response to an activation of a first interactive button on the GUI by the user.

### TECHNICAL FIELD

The present disclosure relates to configuration files of network access device such as modems, and more particularly, relates to generating and detecting errors in configuration files of network access device.

### BACKGROUND

Cable modems are an important component in home or business networking systems. The operation of a cable modem can be hampered by an improper, inoperative, or outdated configuration file. The configuration file can be implemented as binary files based on a type-length-value (TLV) format. These TLV formatted config files can be deployed using a Trivial File Transfer Protocol (TFTP) server, via a dynamic host configuration protocol (DHCP) to the modem.

Typically, a multiple services operator (MSO) manually modifies or writes configuration files (e.g., config files) for cable modems so that the content provider can communicate with a subscriber's local network. The manual processing of the config files can include errors, which prevent the cable modem from operating properly and which are difficult to detect. For example, the MSO may use features that are not supported by a current version of the Data Over Cable Service Interface Specification (DOCSIS) telecommunication standard. Other modem errors can be the result of the MSO having configured the config file with the wrong parameter values. A minor configuration error sometimes will result in ineffectiveness of some features or offline of the modem, and it will take a lot of time for communication and debugging in order to figure out a cause.

There is therefore a need for a method capable of automatically generating a configuration file for the cable modems and detecting errors in the configuration file.

### SUMMARY

Aspects of the present disclosure are directed to an electronic device, comprising: a memory having instructions stored thereon; and a processor configured to execute the instructions stored on the memory to cause the electronic device to: present a Graphical User Interface (GUI) to a user, the GUI including a plurality of selectable elements and one or more parameter controls associated with each of the plurality of selectable elements, each of the plurality of selectable elements corresponding to a feature of a network access device; receive a user selection of at least one of the plurality of selectable elements; receive one or more parameter values associated with the at least one selectable element inputted by the user via the parameter controls; and generate a configuration file of the network access device based at least on the at least one selectable element selected by the user, and the one or more parameter values associated with the at least one selectable element inputted by the user, in response to an activation of a first interactive button on the GUI by the user.

In some embodiments, the processor is further configured to execute the instructions stored on the memory to cause the electronic device to: receive a user selection of a type of the network access device by the use via the GUI, wherein the plurality of selectable elements and the associated parameter controls are presented based on the selected type of the network access device.

In some embodiments, the GUI further comprises a second interactive button associated with each of the plurality of selectable elements, and the processor is further configured to execute the instructions stored on the memory to cause the electronic device to: receive a user selection of a first selectable element of the plurality of selectable elements; receive one or more parameter values associated with the first selectable element inputted by the user; and display, on the GUI, one or more Type-Length-Vale (TLV) of a feature of the network access device corresponding to the first selectable element, in response to an activation of the second interactive button associated with the first selectable element by the user.

In some embodiments, the processor is further configured to execute the instructions stored on the memory to cause the electronic device to: obtain an existing configuration file of the network access device; receive a user selection of a second selectable element of the plurality of selectable elements; receive one or more parameter values associated with the second selectable element inputted by the user; and update the existing configuration file based on the second selectable element selected by the user, and the one or more parameter values associated with the second selectable element inputted by the user, in response to an activation of a third interactive button on the GUI by the user.

In some embodiments, the processor is further configured to execute the instructions stored on the memory to cause the electronic device to: prior to the updating of the existing configuration file, determine existing features of the network access device included in the existing configuration file; and highlight a selectable element on the GUI that corresponds to a feature other than the existing features.

In some embodiments, the processor is further configured to execute the instructions stored on the memory to cause the electronic device to: generate the configuration file of the network access device based on the at least one selectable element selected by the user, the one or more parameter values associated with the at least one selectable element inputted by the user, and a template encapsulating basic features of the network access device, in response to an activation of the first interactive button on the GUI by the user.

Other aspects of the present disclosure are directed to an electronic device, comprising: a memory having instructions stored thereon; and a processor configured to execute the instructions stored on the memory to cause the electronic device to: receive a type of a target network access device, and retrieve a configuration file of the target network access device; detect errors in the configuration file according to a set of predetermined rules; and report the detected errors in the configuration file to a user, and for each of the errors, give a suggestion on how to correct the error according to the set of predetermined rules.

In some embodiments, the processor is further configured to execute the instructions stored on the memory to cause the electronic device to report the errors in the configuration file to the user by popping up a display interface for displaying the detected errors in the configuration file and the suggestion given for each error, or generating a report including the detected errors in the configuration file and the suggestion given for each error.

In some embodiments, the set of predetermined rule includes at least one of: which management information bases (MIBs) and/or parameters should be set in a configuration file of a multimedia terminal adapter (MTA); which MIBs and/or parameters should be set in a configuration file of a cable modem (CM); corresponding MIBs and/or parameters supported by different versions of a DOCSIS configuration file and some features should have corresponding preconditions.

Other aspects of the present disclosure are directed to a method of generating a configuration file of a network access device, comprising: presenting a Graphical User Interface (GUI) to a user, the GUI including a plurality of selectable elements and one or more parameter controls associated with each of the plurality of selectable elements, each of the plurality of selectable elements corresponding to a feature of a network access device; receiving a user selection of at least one of the plurality of selectable elements; receiving one or more parameter values associated with the at least one selectable element inputted by the user via the parameter controls; and generating a configuration file of the network access device based at least on the at least one selectable element selected by the user, and the one or more parameter values associated with the at least one selectable element inputted by the user, in response to an activation of a first interactive button on the GUI by the user.

In some embodiments, the method further comprises receiving a user selection of a type of the network access device via the GUI, wherein the plurality of selectable elements and the associated parameter controls are presented based on the selected type of the network access device.

In some embodiments, the GUI further comprises a second interactive button associated with each of the plurality of selectable elements, and the method further comprises: receiving a user selection of a first selectable element of the plurality of selectable elements; receiving one or more parameter values associated with the first selectable element inputted by the user; and displaying, on the GUI, one or more Type-Length-Vale (TLV) of a feature of the network access device corresponding to the first selectable element, in response to an activation of the second interactive button associated with the first selectable element by the user.

In some embodiments, the method further comprises: obtaining an existing configuration file of the network access device; receiving a user selection of a second selectable element of the plurality of selectable elements; receiving one or more parameter values associated with the second selectable element inputted by the user; and updating existing configuration file based on the second selectable element selected by the user, and the one or more parameter values associated with the second selectable element inputted by the user, in response to an activation of a third interactive button on the GUI by the user.

In some embodiments, the method further comprises: prior to the updating of the existing configuration file, determining existing features of the network access device included in the existing configuration file; and highlighting a selectable element on the GUI that corresponds to a feature other than the existing features.

In some embodiments, the method further comprises generating the configuration file of the network access device based on the at least one selectable element selected by the user, the one or more parameter values associated with the at least one selectable element inputted by the user, and a template encapsulating basic features of the network access device, in response to an activation of the a first interactive button on the GUI by the user.

Other aspects of the present disclosure are directed to a method of detecting errors in a configuration file of a target network access device, comprising: receiving a type of the target network access device and retrieving a configuration file of the target network access device; detecting errors in the configuration file according to a set of predetermined rules; and reporting the detected errors in the configuration file to a user, and for each of the errors, giving a suggestion on how to correct the error according to the set of predetermined rules.

In some embodiments, the method further comprises: reporting the errors in the configuration file to the user by popping up a display interface for displaying the detected errors in the configuration file and the suggestion given for each error, or generating a report including the detected errors in the configuration file and the suggestion given for each error.

In some embodiments, the set of predetermined rules includes at least one of: which management information bases (MIBs) and/or parameters should be set in a configuration file of a multimedia terminal adapter (MTA); which MIBs and/or parameters should be set in a configuration file of a cable modem (CM); corresponding MIBs and/or parameters supported by different versions of a DOCSIS configuration file; and some features should have corresponding preconditions.

Other aspects of the present disclosure are directed to a non-transitory computer readable medium having instructions stored thereon for execution by a processor to perform steps of the method described above.

Other aspects of the present disclosure are directed to an apparatus implemented by an electronic device, comprising means for performing steps of the method described above.

### BRIEF DESCRIPTION OF THE DRAWINGS

For a better understanding of the present disclosure, and to show how the same may be implemented, reference will now be made, by way of example, to the accompanying drawings, in which:

FIG. 1 is a block diagram illustrating an example network environment 100 operable to generate and analyze the config file of a cable modem according to an embodiment of the present disclosure.

FIG. 2 is a flowchart of an exemplary method 200 of generating a configuration file through a graphical user interface according to an embodiment of the present disclosure.

FIG. 3 is a flowchart of an exemplary method 300 of detecting errors in a configuration file of a modem according to an embodiment of the present disclosure.

FIG. 4A is a schematic diagram illustrating an exemplary user interface 400 for generating a configuration file on a graphical user interface, according to an embodiment of the present disclosure.

FIG. 4B is a schematic diagram illustrating an exemplary user interface 420 for detecting errors in the configuration file, according to an embodiment of the present disclosure.

FIG. 5 is a block diagram of an exemplary electronic device 500 according to some embodiments of the present disclosure.

Note that like reference numerals refer to corresponding parts throughout the drawings. Moreover, multiple instances of the same part are designated by a common prefix separated from an instance number by a dash.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

Exemplary embodiments of the present disclosure are directed to a solution for automatically generating and detecting errors in config files for an access point in a network, such as a cable modem. According to an exemplary embodiment, the config files can include one or more feature files, such as binary files including TLV elements. Basic features and/or TLV elements to be included in a config file can be encapsulated into a template, which is stored in a database.

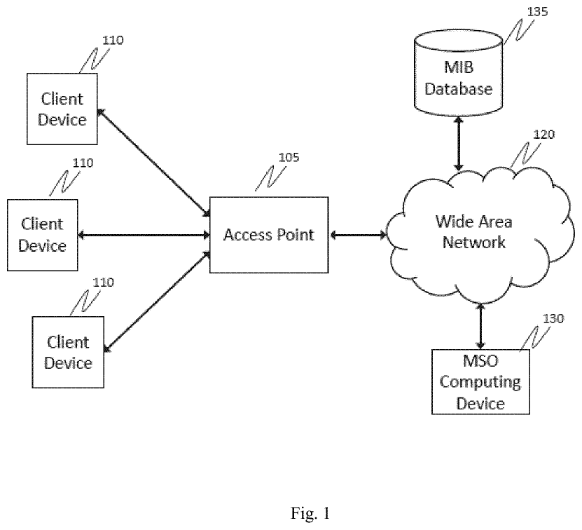

FIG. 1 is a block diagram illustrating an example network environment 100 operable to generate and analyze the config file of a cable modem according to an embodiment of the present disclosure.

According an exemplary embodiment, an access point 105 may allow communications between a content provider to and from one or more client devices 110 for the viewing of media content. For example, the one or more client devices 110 may be provisioned to receive video service(s), data service(s), and/or voice services through the access point 105. In embodiments, an access point 105 may include a gateway, a cable modem, a wireless router including an embedded cable modem, a mobile hot-spot router, a multimedia over coaxial alliance (MoCA) node, and any other network access device that is operable to route communications to and from a client device 110.

Once connected to content provider provided by the access point 105, a client device 110 may receive content and/or services from upstream networks or servers (e.g., wide area network (WAN) 120), and may communicate with other client devices 110 connected to the same content provider. For example, communications between client devices 110 and an access point 105 may include wireless communications (e.g., 802.11 packet exchanges).

According to exemplary embodiments of the present disclosure, an access point 105 may route communications between client device(s) 110 and a wide area network (WAN) 120. A multiple service operator (MSO) 130, which can be associated with the content provider, can be located upstream from the WAN 120. The MSO 130 can have one or more computing devices for command and control of the media content provided to the access point 105. The MSO 130 can also provide restorative and repair services for subscriber's when access points 105 and/or client devices 110 malfunction or are inoperable such that media content is inaccessible.

Product defects occur during the use of a network access device such as a modem. By debugging a large number of product defects for modems reported by the customers, it was found that these defects are all caused by errors in the configuration file. In view of this, the present disclosure proposes a method for automatically generating a correct configuration file for network access devices based on GUI.

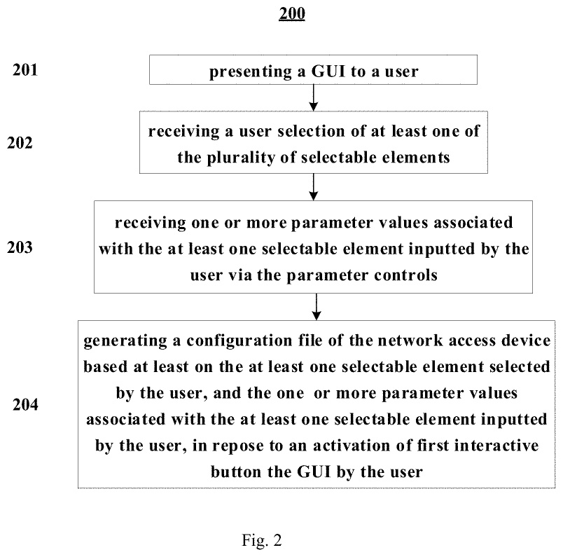

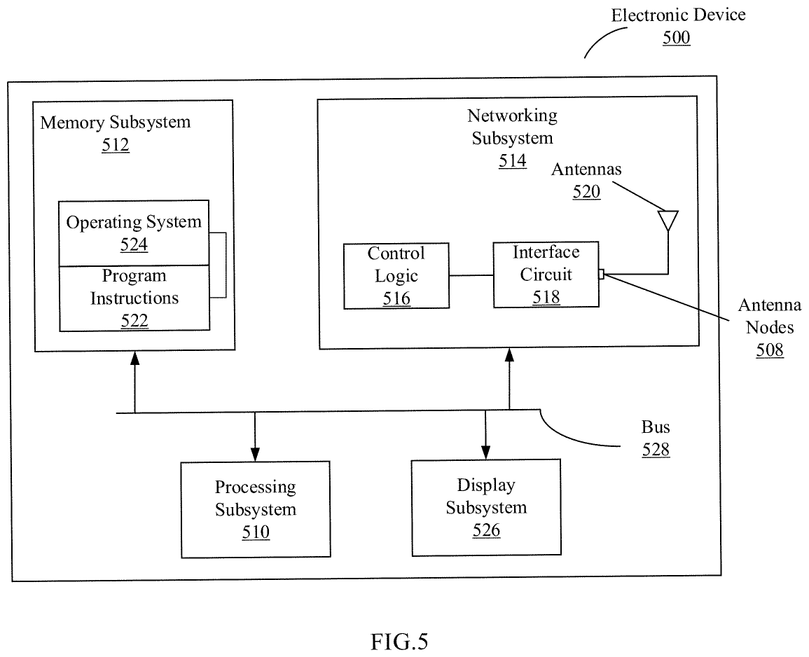

FIG. 2 is a flowchart of an exemplary method 100 of generating a configuration file through GUI according to an embodiment of the present disclosure. Such method can be performed by the electronic device as shown in FIG. 5. As shown in FIG. 2, at step 201, presenting a GUI to a user. The GUI includes a plurality of selectable elements and one or more parameter controls associated with each of the plurality of selectable elements. Each of the plurality of selectable elements corresponds to a feature of a network access device. It should be understood that, the GUI presented to the user is not necessary to be presented locally to the electronic device used by the user, but may be presented to the user on a device remotely located from the local electronic device used, and the local electronic device being in communication with the remote device to enable the GUI to be presented on the remote device.

In some embodiments, the above selectable elements can be for example check boxes, and the above parameter controls can be for example drop-down menus or input boxes.

At step 202, receiving a user selection of at least one of the plurality of selectable elements. At step 203, receiving one or more parameter values associated with the at least one selectable element inputted by the user via the parameter controls.

After the user selects the desired features and sets the parameters for the desired features, at step 204, generating a configuration file of the network access device based at least on the at least one selectable element selected by the user, and the one or more parameter values associated with the at least one selectable element inputted by the user, in response to an activation of a first interactive button on the GUI by the user. The first interactive button is a “generate configuration file” button, and may be located in the lower right corner of the GUI, and such button can be activated upon receiving a mouse click, and such button can also be activated by pressing the “enter” key.

According to the embodiments, the method 200 further includes receiving a user selection of a type of the network access device via the GUI, and the plurality of selectable elements and the associated parameter controls on the GUI are presented based on the selected type of the network access device.

Existing config files can also be updated. According to the embodiments, additional features that need to be added can be generated for users to copy into existing config files. In this case, the GUI further includes a second interaction button associated with each selectable element, and such second interaction button can be “generate TLVs” button.

According to an exemplary embodiment, a user selection of a first selectable element of the plurality of selectable elements corresponding to the additional feature that needs to be added is received, and one or more parameter values associated with the first selectable element inputted by the user are received, and then one or more TLVs of the feature of the network access device corresponding to the first selectable element are displayed on the GUI for users to copy into existing config files, in response to an activation of the second interactive button associated with the first selectable element by the user.

According to the embodiment of the present disclosure, updating the existing config file can also include updating the existing config files automatically. According to an exemplary embodiment, an existing configuration file of the network access device can be obtained such as by the user uploading the existing configuration file. Then a user selection of a second selectable element of the plurality of selectable elements corresponding to the additional feature that needs to be added is received and one or more parameter values associated with the second selectable element inputted by the user are received. Then the existing configuration file is updated based on the second selectable element selected by the user, and the one or more parameter values associated with the second selectable element inputted by the user, in response to an activation of a “update configuration file” button on the GUI by the user.

According to the embodiment of the present disclosure, the existing features of the network access device included in the existing configuration file can be determined prior to the updating of the existing configuration file, and then a selectable element on the GUI that corresponds to a feature other than the existing features can be highlighted.

According to the embodiment of the present disclosure, the step 204 can further include generating the configuration file of the network access device based on the at least one selectable element selected by the user, the one or more parameter values associated with the at least one selectable element inputted by the user, and a template encapsulating basic features of the network access device, in response to an activation of the “generate configuration file” button on the GUI by the user.

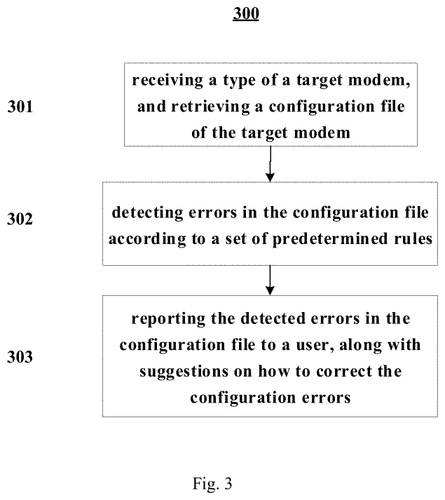

During the online process of the modem, the modem will automatically go to a TFTP server configured by the MSO to download a configuration file, then read the configuration file and perform some basic checks, and the checked errors usually can be viewed only through a serial port, but the MSO generally is not connected with the serial port or serial ports of many modems are usually closed due to safety considerations, so the MSO is generally not aware of the errors. In order for the MSO to be aware of the errors checked, the present disclosure proposes a solution to display the errors on a Graphical User Interface (GUI). Meanwhile, because the existing detection is relatively simple, the present disclosure also provides a solution to more comprehensively detect the downloaded configuration file based on an expanded predetermined rule. The method capable of detecting the errors in the configuration file of a network access device such as a modem according to the embodiments of the present disclosure can be implemented through either the web-based interface or a built-in module of the modem. This is described specifically with reference to FIG. 3.

FIG. 3 is a flowchart of an exemplary method 300 of detecting errors in a configuration file of a modem, according to an embodiment of the present disclosure.

As shown in FIG. 3, at step 301, receiving a type of a target modem, and retrieving a configuration file of the target modem. In the case where detection of errors in the configuration file is accomplished through the web-based interface, the configuration file of the modem is acquired by receiving the configuration file of the modem uploaded by a user (e.g., MSO). In the case where detection of errors in the configuration file is accomplished through a built-in module of the modem, the configuration file of the modem is acquired by downloading the configuration file of the modem during its online process.

At step 302, detecting errors in the configuration file according to a set of predetermined rules. The predefined rules may include at least one of which Management Information Bases (MIBs) and/or parameters should be in a configuration file of a Multimedia Terminal Adapter (MTA), which MIBs and/or parameters should be in a configuration file of a Cable Modem (CM), which MIBs and/or parameters should not be placed in a configuration file, and corresponding MIBs and/or parameters supported by different versions of a DOCSIS configuration file, etc. For example, pktc * MIB is a PacketCable/MTA MIB, and should be in an MTA configuration file instead of a CM configuration file. For example, the DOCSIS 3.1 platform does not support arrisRouter*, and does not support arrisCmDevXXX mibs anymore (e.g., not supporting the following Snmp mibs: {ArrisCmDevHttpWanages.0 Advanced}, {ArrisCmDevTelnetTelnetEnable. O PermeEnable}, {ArrisCmDevTelnetAllow.0 allow}, {ArrisCmDevSSHEable. 0 PermeEnable}, and {ArrisCmDevSSHAllow.0 allow}, etc. anymore), and these mibs should be replaced with arrisCmDoc 30XXX mibs, and so on.

The predetermined rule may also include that some features should have corresponding preconditions. For example, in order to enable Bandsteering, it is necessary to set basic parameters such as “BSSID”, “BssSecurityMode”, “WPAPreShareKey” before setting ARRISRouterBSSBandSteeringEnable to “true”. Specifically, a configuration example to implement Bandsteering is given below:
Set arrisRouter Bss1D. 10001 to bandsteering
Set arrisRouter Bss1D. 10101 to bandsteering
Set arrisRouterBssSecuritymode. 10001 to wpaWpa2Psk
Set arrisRouterBssSecuritymode. 10101 to wpaWpa2Psk
Set arrisRouterWPAPreSharedKey. 10001 to autotest1223
Set arrisRouterWPAPreSharedKey. 10101 to autotest1223
Set arrisRouterBSSBandSteeringEnable to true.

The predetermined rule of the present disclosure may be modified or further expanded as desired. For example, after DOCSIS has a new version, the corresponding MIBs and parameters supported in the new version may be expanded.

After errors in the configuration file are detected according to predetermined rules, at step 303, reporting the detected errors in the configuration file to the user, along with suggestions on how to correct the configuration errors. In case where the detection of errors in the configuration file is accomplished through the web-based interface, the errors may be reported to the user either by popping up a display interface that displays the detected errors in the configuration file or by generating a report. In case where the detection of errors in the configuration file is accomplished through a built-in module of the modem, the detected errors may be reported to the user on a configuration page of the router, either by popping up on the page a display interface that displays the detected errors in the configuration file or by generating a report.

According to an embodiment of the present disclosure, while the detected errors in the configuration file is reported to the user, a suggestion on how to correct the configuration errors can be given according to the predetermined rule. For example, upon detecting an error that pktc * MIB is placed in a CM configuration file, it is suggested to delete pktc * MIB from the CM configuration file while displaying or reporting the error to the user; when detecting the presence of “ArrisCmDevHttpWanacess.0 Advanced” mib on the DOCSIS 3.1 platform, it is suggested to replace this mib with “arrisCmDoc30HttpWanacess.0 Advanced” mib and so on.

By presenting the detected errors to the user in the form of a pop-up page display or generated report, the user (e.g., MSO) may be aware of where the errors occurred more clearly and intuitively. By giving a correction suggestion while reporting the error, the user can quickly repair the error, which can save the time for communication and query spent on repairing the error for the user, and greatly improve user experience.

According to an embodiment of the present disclosure, the web-based interface is a web page accessed through a browser. In the case of generating a configuration file or detecting errors in the configuration file through the web-based interface, a user (e.g., an MSO staff) needs to enter a credential (e.g., a username and password) to log into the modem developer's official website to access the interface for generation and/or detection. In case where the detection of errors in the configuration file is accomplished through a built-in module of the modem, the user usually runs the detection operation on a page for configuring the router.

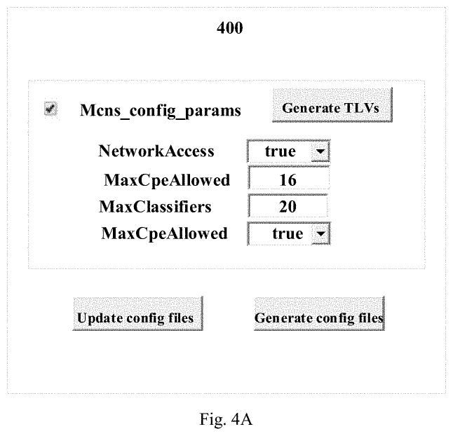

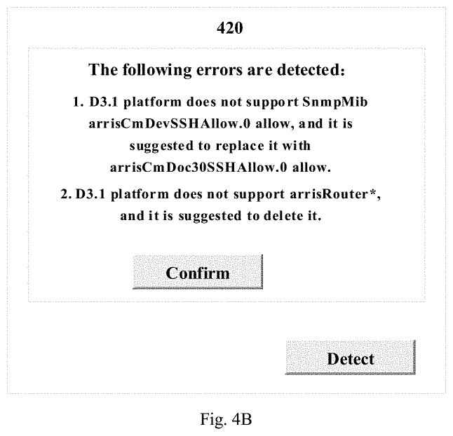

FIG. 4A is a schematic diagram illustrating a user interface 400 for generating a configuration file on a GUI, according to an embodiment of the present disclosure. FIG. 4B illustrates a schematic diagram of a user interface 420 for detecting errors in a configuration file, according to an embodiment of the present disclosure. For simplicity of illustration, only one selectable element is shown in FIG. 4A, and FIG. 4B only shows a schematic diagram illustrating displaying the detected errors and suggestions on how to correct the errors in the form of a pop-up message after the detection. It should be appreciated that the user interfaces shown in FIGS. 4A and 4B are merely illustrative, in actual use the number of selectable elements may correspond to the number of all configurable features, the detected errors may be presented to the user also by way of a generated report, and other forms of user interfaces may be employed.

Whether or not the modem can be brought online and whether various features of the modem can be used all depend on its configuration file. According to embodiments of the present disclosure, the configuration file of the modem is automatically generated, so that errors caused by manually editing the configuration file can be avoided. Meanwhile, by detecting the configuration file in the online process of the modem or before the MSO configures the configuration file of the modem on the TFTP server so as to detect errors possibly existing in the configuration file and correct the errors in time as suggested, product defects produced in subsequent usage processes can be avoided, a large amount of time for communication and debugging can be saved for MSO and after-sale engineers of the modem, and the user experience is further improved.

FIG. 5 is an exemplary block diagram of an exemplary electronic device 500 according to an embodiment of the present disclosure. The electronic device 500 may be used to perform various methods, such as the methods 200, 300, and various additional methods, according to the embodiments of the present disclosure.

FIG. 5 presents a block diagram illustrating an example of an electronic device 500 in accordance with some embodiments. This electronic device includes processing subsystem 510, memory subsystem 512, and networking subsystem 514. Processing subsystem 510 includes one or more devices configured to perform computational operations. For example, processing subsystem 510 can include one or more microprocessors, ASICs, microcontrollers, programmable-logic devices, graphical processor units (GPUs) and/or one or more digital signal processors (DSPs).

Memory subsystem 512 includes one or more devices for storing data and/or instructions for processing subsystem 510 and networking subsystem 514. For example, memory subsystem 512 can include dynamic random access memory (DRAM), static random access memory (SRAM), and/or other types of memory (which collectively or individually are sometimes referred to as a ‘computer-readable storage medium’). In some embodiments, instructions for processing subsystem 510 in memory subsystem 512 include: one or more program modules or sets of instructions (such as program instructions 522 or operating system 524), which may be executed by processing subsystem 510. Note that the one or more computer programs may constitute a computer-program mechanism. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate on a wired and/or wireless network (i.e., to perform network operations), including: control logic 516, an interface circuit 518 and one or more antennas 520 (or antenna elements). (While FIG. 5 includes one or more antennas 520, in some embodiments electronic device 500 includes one or more nodes, such as nodes 508, e.g., a pad, which can be coupled to the one or more antennas 520. Thus, electronic device 500 may or may not include the one or more antennas 520.) For example, networking subsystem 514 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 500 may be adapted or changed using pattern shapers (such as reflectors) in one or more antennas 520 (or antenna elements), which can be independently and selectively electrically coupled to ground to steer the transmit antenna radiation pattern in different directions. Thus, if one or more antennas 520 includes N antenna-radiation-pattern shapers, the one or more antennas 520 may have 2N different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 4 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting frames and/or scanning for frames transmitted by other electronic devices.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc.

Electronic device 500 can be (or can be included in) any electronic device with at least one network interface. For example, electronic device 500 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, an access point, test equipment, and/or another electronic device.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5. Also, although separate subsystems are shown in FIG. 5, in some embodiments some or all of a given subsystem or component can be integrated into one or more of the other subsystems or component(s) in electronic device 500. For example, in some embodiments program instructions 522 are included in operating system 524 and/or control logic 516 is included in interface circuit 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 514. The integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 522, operating system 524 (such as a driver for interface circuit 518) or in firmware in interface circuit 518. Alternatively or additionally, at least some of the operations in the communication techniques may be implemented in a physical layer, such as hardware in interface circuit 518.

The present disclosure may be implemented as any combination of an apparatus, a system, an integrated circuit, and a computer program on a non-transitory computer readable recording medium. The one or more processors may be implemented as an integrated circuit (IC), an application specific integrated circuit (ASIC), or large scale integrated circuit (LSI), system LSI, super LSI, or ultra LSI components that perform a part or all of the functions described in the present disclosure.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term computer-readable recording medium refers to any computer program product, apparatus or device, such as a magnetic disk, optical disk, solid-state storage device, memory, and programmable logic devices (PLDs), used to provide machine instructions or data to a programmable data processor, including a computer-readable recording medium that receives machine instructions as a computer-readable signal.

By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the present disclosure. Various embodiments may omit, substitute, or add various procedures or components as appropriate. For instance, features described with respect to certain embodiments may be combined in other embodiments.

Similarly, while operations are depicted in the drawings in a particular order, this should not be understood as requiring that such operations be performed in the particular order shown or in sequential order, or that all illustrated operations be performed, to achieve desirable results. In some cases, multitasking and parallel processing may be advantageous.

1. An electronic device, comprising:
a memory having instructions stored thereon; and
a processor configured to execute the instructions stored on the memory to cause the electronic device to:
present a Graphical User Interface (GUI) to a user, the GUI including a plurality of selectable elements and one or more parameter controls associated with each of the plurality of selectable elements, each of the plurality of selectable elements corresponding to a feature of a network access device;
receive a user selection of at least one of the plurality of selectable elements;
receive one or more parameter values associated with the at least one selectable element inputted by the user via the parameter controls; and
generate a configuration file of the network access device based at least on the at least one selectable element selected by the user, and the one or more parameter values associated with the at least one selectable element inputted by the user, in response to an activation of a first interactive button on the GUI by the user.

2. The electronic device according to claim 1, wherein the processor is further configured to execute the instructions stored on the memory to cause the electronic device to:
receive a user selection of a type of the network access device by the use via the GUI,
wherein the plurality of selectable elements and the associated parameter controls are presented based on the selected type of the network access device.

3. The electronic device according to claim 1, wherein the GUI further comprises a second interactive button associated with each of the plurality of selectable elements, and wherein the processor is further configured to execute the instructions stored on the memory to cause the electronic device to:
receive a user selection of a first selectable element of the plurality of selectable elements;
receive one or more parameter values associated with the first selectable element inputted by the user; and
display, on the GUI, one or more Type-Length-Vale (TLV) of a feature of the network access device corresponding to the first selectable element, in response to an activation of the second interactive button associated with the first selectable element by the user.

4. The electronic device according to claim 1, wherein the processor is further configured to execute the instructions stored on the memory to cause the electronic device to:
obtain an existing configuration file of the network access device;
receive a user selection of a second selectable element of the plurality of selectable elements;
receive one or more parameter values associated with the second selectable element inputted by the user; and
update the existing configuration file based on the second selectable element selected by the user, and the one or more parameter values associated with the second selectable element inputted by the user, in response to an activation of a third interactive button on the GUI by the user.

5. The electronic device according to claim 4, wherein the processor is further configured to execute the instructions stored on the memory to cause the electronic device to:
prior to the updating of the existing configuration file, determine existing features of the network access device included in the existing configuration file; and
highlight a selectable element on the GUI that corresponds to a feature other than the existing features.

6. The electronic device according to claim 1, wherein the processor is further configured to execute the instructions stored on the memory to cause the electronic device to:
generate the configuration file of the network access device based on the at least one selectable element selected by the user, the one or more parameter values associated with the at least one selectable element inputted by the user, and a template encapsulating basic features of the network access device, in response to an activation of the first interactive button on the GUI by the user.

7. An electronic device, comprising:
a memory having instructions stored thereon; and
a processor configured to execute the instructions stored on the memory to cause the electronic device to:
receive a type of a target network access device, and retrieve a configuration file of the target network access device;
detect errors in the configuration file according to a set of predetermined rules; and
report the detected errors in the configuration file to a user, and for each of the errors, give a suggestion on how to correct the error according to the set of predetermined rules.

8. The electronic device according to claim 7, wherein the processor is further configured to execute the instructions stored on the memory to cause the electronic device to:
report the errors in the configuration file to the user by popping up a display interface for displaying the detected errors in the configuration file and the suggestion given for each error, or generating a report including the detected errors in the configuration file and the suggestion given for each error.

9. The electronic device according to claim 7, wherein the set of predetermined rules includes at least one of:
which management information bases (MIBs) and/or parameters should be set in a configuration file of a multimedia terminal adapter (MTA);
which MIBs and/or parameters should be set in a configuration file of a cable modem (CM);
corresponding MIBs and/or parameters supported by different versions of a DOCSIS configuration file; and
some features should have corresponding preconditions.

10. A method of generating a configuration file of a network access device, comprising:
presenting a Graphical User Interface (GUI) to a user, the GUI including a plurality of selectable elements and one or more parameter controls associated with each of the plurality of selectable elements, each of the plurality of selectable elements corresponding to a feature of a network access device;
receiving a user selection of at least one of the plurality of selectable elements;
receiving one or more parameter values associated with the at least one selectable element inputted by the user via the parameter controls; and
generating a configuration file of the network access device based at least on the at least one selectable element selected by the user, and the one or more parameter values associated with the at least one selectable element inputted by the user, in response to an activation of a first interactive button on the GUI by the user.

11. The method according to claim 10, further comprising:
receiving a user selection of a type of the network access device via the GUI,
wherein the plurality of selectable elements and the associated parameter controls are presented based on the selected type of the network access device.

12. The method according to claim 10, wherein the GUI further comprises a second interactive button associated with each of the plurality of selectable elements, and the method further comprising:
receiving a user selection of a first selectable element of the plurality of selectable elements;
receiving one or more parameter values associated with the first selectable element inputted by the user; and
displaying, on the GUI, one or more Type-Length-Vale (TLV) of a feature of the network access device corresponding to the first selectable element, in response to an activation of the second interactive button associated with the first selectable element by the user.

13. The method according to claim 10, further comprising:
obtaining an existing configuration file of the network access device;
receiving a user selection of a second selectable element of the plurality of selectable elements;
receiving one or more parameter values associated with the second selectable element inputted by the user; and
updating existing configuration file based on the second selectable element selected by the user, and the one or more parameter values associated with the second selectable element inputted by the user, in response to an activation of a third interactive button on the GUI by the user.

14. The method according to claim 13, further comprising:
prior to the updating of the existing configuration file, determining existing features of the network access device included in the existing configuration file; and
highlighting a selectable element on the GUI that corresponds to a feature other than the existing features.

15. The method according to claim 10, further comprising:
generating the configuration file of the network access device based on the at least one selectable element selected by the user, the one or more parameter values associated with the at least one selectable element inputted by the user, and a template encapsulating basic features of the network access device, in response to an activation of the a first interactive button on the GUI by the user.

16. A method of detecting errors in a configuration file of a target network access device, comprising:
receiving a type of the target network access device and retrieving a configuration file of the target network access device;
detecting errors in the configuration file according to a set of predetermined rules; and
reporting the detected errors in the configuration file to a user, and for each of the errors, giving a suggestion on how to correct the error according to the set of predetermined rules.

17. The method according to claim 16, further comprising:
reporting the errors in the configuration file to the user by popping up a display interface for displaying the detected errors in the configuration file and the suggestion given for each error, or generating a report including the detected errors in the configuration file and the suggestion given for each error.

18. The method according to claim 16, wherein the set of predetermined rules includes at least one of:
which management information bases (MIBs) and/or parameters should be set in a configuration file of a multimedia terminal adapter (MTA);
which MIBs and/or parameters should be set in a configuration file of a cable modem (CM);
corresponding MIBs and/or parameters supported by different versions of a DOCSIS configuration file; and
some features should have corresponding preconditions.

19. A non-transitory computer readable medium having instructions stored thereon for execution by a processor to perform steps of the method according to claim 10.

20. An apparatus implemented by an electronic device, comprising means for performing steps of the method according to claim 10.
